(19) United States
(12) Patent Application Publication
(10) Pub. No.: US 2023/0336823 A1
(43) Pub. Date: Oct. 19, 2023

(54) Real-Time Adaptive Content Generation with Dynamic Sentiment Prediction

(71) Applicant: Cole Brayton Johnson, Atlanta, GA (US)

(72) Inventor: Cole Brayton Johnson, Atlanta, GA (US)

(21) Appl. No.: 18/339,107

(22) Filed: Jun. 21, 2023

(51) Int. Cl. H04N 21/466; G06F 16/735

(52) U.S. Cl. CPC H04N 21/4668; G06F 16/735; H04N 21/4667

(57) ABSTRACT

A system to dynamically encode, analyze, and subsequently decode user sentiment to adaptively generate temporally coherent media in real-time, thereby eliciting intended sentiment in the user. The enclosed system design unites sentiment analysis and generative media frameworks within a variational autoencoding structure, thus facilitating a continuous feedback loop between the user and the media that persistently adapts to the user's evolving sentiment.

### BACKGROUND

The invention relates generally to generative artificial intelligence, sentiment analysis and natural language processing, personalization and recommendation algorithms, and human-computer interaction.

Cutting-edge generative Al technologies, capable of creating novel content like images, videos, and music by learning from vast datasets, are revolutionizing various industries. These technologies employ machine learning models such as Generative Adversarial Networks (GANs), Variational Autoencoders (VAEs), and transformers. GANs, comprising of a generator and a discriminator, excel in producing lifelike images. VAEs modify and enrich existing content like images or videos, while transformers generate intricate and logical language.

Emotional intelligence has been added to Al systems in an attempt to improve user engagement and experience. These systems try to understand and respond to human emotions, and even simulate emotions in Al agents. By combining different data sources, like audio, visual, and text, developers are trying to improve emotion recognition. Some approaches aim to predict subtle emotional states instead of general categories, in an effort to understand user emotions better and to provide somewhat tailored system responses.

Despite progress in generative content and emotional Al, current systems have shortcomings. Existing content creation systems, which use user feedback loops, select from pre-existing media and need explicit user direction to change, resulting in a non-intuitive experience. Moreover, while research on the bidirectional relationship between sentiment and content exists, a smooth pipeline to adjust system responses based on user feedback is lacking. Hence, there's a demand for advanced systems that can create dynamic content in real-time, induce specific user sentiments, and continually adapt to changing user responses.

### BRIEF SUMMARY OF THE INVENTION

This summary is provided to introduce selected concepts that are further described in the Detailed Description below. The purpose of this summary is not to identify key features or essential features of the claimed subject matter, nor is it intended to be used as an aid in determining the scope of the disclosure.

The present invention introduces a system and method for continually generating media content in real-time that is specifically tailored to the individual user's evolving sentiment. The central idea behind the invention is the integration of generative media AI and sentiment analysis technologies to continuously create and adapt media content across various formats during the course of the user's exposure to it. By continuously monitoring and analyzing reactions through the detectable data points displayed by the user (cues), the system intelligently adjusts the content, providing a highly personalized and engaging experience.

This invention significantly differentiates itself from prior art by introducing a generative AI system that actively creates content in real-time, designed to elicit specific sentiment in users. In doing so, it creates a far superior user experience than systems which merely curate from a repository of pre-existing media. Moreover, the invention circumvents the drawbacks of current emotion analysis technology by developing a continually updated computational model of the user's media perception based on their interactions and responses. This enables an enhanced comprehension of the cause- and-effect relationship between media content and users' emotions. By unifying generative content creation and causal sentiment recognition systems into a single feedback loop, we substantially augment the capabilities of existing disparate technologies, thereby facilitating a more immersive and personalized media experience.

The invention leverages recent breakthroughs in generative AI, deep learning, and multimodal data analysis and is enabled by the availability of advanced computational resources. These developments enable the AI system to better interpret human sentiment from multimodal cues, create highly convincing images, videos, and text, process vast amounts of data to extract meaningful patterns, and develop a more comprehensive understanding of users' sentimental experiences. Consequently, the system can generate more relevant and sentimentally resonant content, setting it apart from existing solutions and demonstrating its potential value across a diverse array of applications and industries.

### INDUSTRY RELEVANCE AND USE CASES

The present invention relates to, but is not limited to, the following use cases. In the short-form, micro-content embodiment, the primary user cue considered is likely to be the view duration of each content segment. The system adapts ensuing content by pre-generating the current content based on data gathered from both the user's session and longer-term data. Each user interaction event or batch of view events can trigger the generation of new content, utilizing the most recent data. Unless specified by the user through a method similar to genre selection, the primary goal of the system is to increase user engagement with the content.

In the informational content embodiment, the system generates various content forms, including tutorials, news articles, and explainer videos, based on the user's preferences and sentiments. The invention adjusts based on computational modelling of users' cognitive preferences by analyzing their sentimental responses to previously attempted communicatory methods. The system adapts the presentation of information according to users' comprehension and content-based preferences, while maintaining an adherence to objective truth.

In the long-form storytelling media embodiment, user preferences can be determined either explicitly by the user or inferred through progressive classifications of user cues and sentimental responses, culminating in an estimation of their anticipated experience. The invention can employ a sentiment-based entropy minimization approach in order to eventually expose users to content predicted to cause the intended sentimental responses based on their session preferences, ensuring a well-crafted storyline that appeals to the user. The system design, moreover, allows for maintaining long-distance temporal connections, ensuring that the storyline remains coherent while undergoing adaptation.

These use cases have significant implications across various industries and platforms. In the entertainment sector, the system allows for the creation of movies, TV shows, video games, short-form videos, etc. that continually adjust to users' states and preferences, providing an immersive and tailored experience. In advertising, real-time adaptive personalization facilitates the generation of highly targeted ads that evolve in response to user sentiment, maximizing relevance, impact, engagement, and action. In the education sector, the system can create instructional materials that adapt to students' learning styles and emotional states on-the-fly, fostering an engaging and effective learning experience. By utilizing the proposed system in real-time, the system can dynamically modify the pace, complexity, and presentation style of educational content to better suit individual students' needs, maximizing comprehension, retention, and motivation. News communication can benefit from real-time adaptation as well, presenting users with articles and reports that cater to their interests and preferences. Moreover, the system can tailor not only the content but also the method with which the content is communicated, based on previously successful methods of reasoning, analogy, explanatory depth, and other cognitive tools that resonate with the user. These exemplary use cases illustrate the diverse and impactful applications of the real-time adaptive personalization system as claimed in the present invention.

### BRIEF DESCRIPTION OF THE DRAWINGS

FIG. 1: Sentiment Recognition

A schematic describing the method by which the sentiment recognition model is trained and communicate its output to the media generation system.

FIG. 2: Branching Illustration

A tree schematic illustrating the relation of sentiment labels, as computed by the media generation system, contextualized with previously generated labels.

FIG. 3: Comparison System

A schematic illustrating the inputs and output of the comparison system, used to compare the user's current sentiment and the desired sentiment.

FIG. 4: Overarching Autoencoder Framework

A basic illustration of the system's high-level similarity to an autoencoding network.

FIG. 5: Adaptive Timeline

A timeline scheme describing the sequence of steps that the generative pipeline and sentiment recognition systems take.

FIG. 6: Training Loops

A schematic describing the data and labels used in the respective subsystems' training loops.

FIG. 7: System Overview

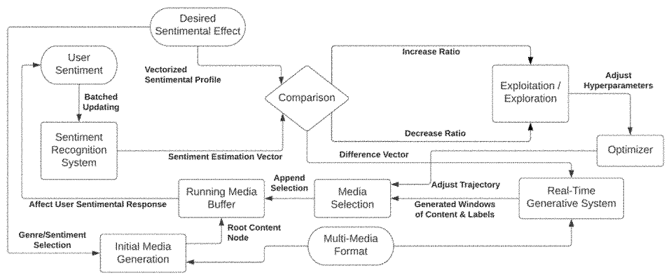

A schematic illustrating the communication of information between subsystems in a real-time feedback loop described herein.

FIG. 8: Generative System

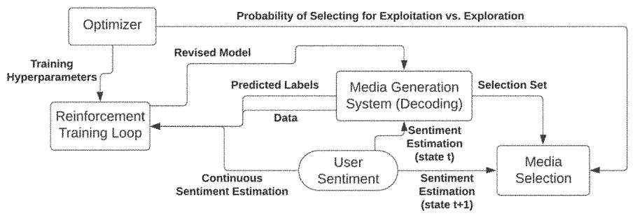

A schematic describing the method by which the media generation system is trained and outputs to the comparison system.

### DETAILED DESCRIPTION OF THE INVENTION

The various technologies described herein are presented with sufficient specificity to meet statutory requirements. However, the description itself is not intended to limit the scope of this disclosure. Instead, the inventors have considered that the claimed subject matter may also be embodied in other ways, including different steps or combinations of steps similar to those described in this document, in conjunction with other present or future technologies.

Most generally, the term “media” is herein used to refer to any channel, system, or technology that facilitates the creation, transmission, and comprehension of information or messages, encompassing both human and non-human interfaces. Although the terms “step” or “block” may be used herein to denote different elements of the methods employed, these terms should not be interpreted as implying any particular order among or between the various steps disclosed, unless the order of individual steps is explicitly described. As a composition of steps, a “pipeline” should be understood as a specific system design. The term “based on” generally indicates that the subsequent object, data, or information is used in performing the preceding action. The terms “feedback loop” or “feedback” generally describes a subsystem which conveys information in a cyclical fashion and may be subject to modification throughout the course of its communication. The terms “sentiment” or “sentimental” refer generally to the emotion, attitude, opinion, and/or belief an individual holds with respect to an entity or concept. The term “cue” may be used to describe the detectable data points displayed by an individual. The term “user-specific” refers to all data related to the user, while “session-specific” pertains to data from the current usage session in which the user is active. The term “subject-dependent” refers generally to data or systems trained on data associated with a specific user and “subject-independent” refers generally to data or systems trained on data associated with many users. The term “continuation” may generally include disjoint short-form media, storyline extensions, or any coherent media content progression, depending on context and format. The term ‘context’ is generally used as a technical reference to peripheral and potentially implicit model inputs. Finally, the term ‘desired sentiment’ is used generally to refer to the optimal sentiment that the system could possibly affect and should not necessarily be interpreted as static throughout the course of a user's session.

The present invention mainly refers to the field of artificial intelligence which has seen significant advancements in the last few decades, with Machine Learning (ML) emerging as a pioneering field. Within ML, reinforcement learning (RL) has emerged as a promising approach for teaching computers to learn from their interactions with the environment. RL models learn to make decisions by exploring an environment, taking actions, and receiving rewards or penalties based on those actions. The learning process involves an agent, states, actions, and rewards. The agent learns a policy, which is a mapping from states to actions, that maximizes the expected cumulative reward over time. Key components of RL include the exploration-exploitation trade-off, various algorithms such as Q-learning and SARSA, and techniques for managing the state-action space such as function approximation, deep learning, and Monte Carlo methods.

In parallel, the field of Natural Language Processing (NLP) has witnessed revolutionary changes due to the advent of transformer-based models. These models use a mechanism called attention to weigh the influence of different input words on each output word. The transformer architecture, introduced in the seminal paper “Attention is All You Need” by Vaswani et al., has become the backbone of numerous state-of-the-art models in NLP, such as BERT, GPT, and T5. It consists of an encoder that processes the input and a decoder that produces the output, both of which are made up of layers containing self-attention and feed-forward neural networks.

One of the most influential transformer-based models is the Large Language Model (LLM), which is designed to generate human-like text. LLMs are trained on a large corpus of text data and can generate coherent and contextually relevant sentences by, for example, predicting the next word in a sequence. These models leverage the power of transformers and attention mechanisms to understand long-range dependencies in language and generate high-quality text.

Training such models requires sophisticated optimization algorithms and carefully crafted loss functions. Gradient descent and its variants (e.g., Stochastic Gradient Descent, Adam, RMSprop) are the most commonly used optimization algorithms. These methods iteratively adjust the model's parameters to minimize a loss function, which quantifies the difference between the model's predictions and the actual data. Commonly used loss functions include Mean Squared Error for regression tasks, Cross-Entropy for classification tasks, and the REINFORCE loss for reinforcement learning tasks.

Training data is typically divided into three splits: training, validation, and test sets. The training set is used to train the model, the validation set is used to tune hyperparameters, and the test set is used to evaluate the final model's performance. Hyperparameters are adjustable parameters that determine the learning process of the model. They are set before training and include factors like learning rate, batch size, and the number of epochs or iterations. The learning rate controls how much to adjust the model in response to the estimated error each time the model weights are updated. Batch size refers to the number of training examples utilized in one iteration, while epochs are the number of complete passes through the entire training dataset. Tuning these hyperparameters on the validation set allows for adjustments to the model's complexity and can help prevent overfitting. The process of splitting the data into these three subsets aids allows for the iterative improvement of the model's performance.

### Sentiment Estimation

The present invention provides a method and system for deducing user sentiment from their engagement patterns or cues, recorded through diverse multimodal formats. This system uses various techniques to record user cues, which reflect their experience and sentiment.

The process of inferring user sentiment based on cues can be conceptually likened to the encoding step in an autoencoder. In this context, the system maps the raw input data, which comprises the observed user cues, to a lower-dimensional representation, akin to a latent space. This latent space captures essential features of the input data, in this case, the user's sentiment. However, it is worth noting that the latent space is not necessarily restricted to a singular interpretation, such as sentiment, and may potentially encode other meaningful information about the user's engagement patterns.

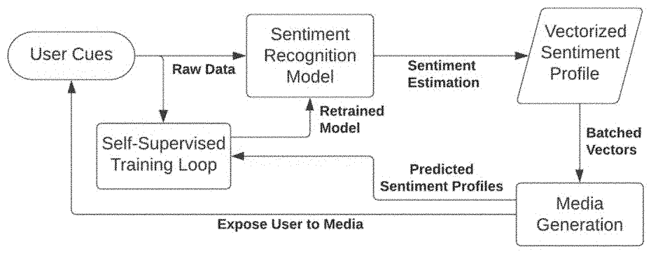

The sentiment estimation latent space is conceptually understood as each dimension representing a different aspect of the user's attitude, opinion, or belief. The magnitude of a value along each dimension in this space represents the valence of the respective sentiment. The system uses transformer networks to process user cues in a time-dependent context, thus considering the temporal nature of user engagement. Each dimension, moreover, is tuned in computational representation through an offline analysis of fine-grained affective states using user-independent data. This system and the ensuing description is illustrated in FIG. 1.

In the context of deducing user sentiment from cues, Transformer models serve as an excellent choice due to their inherent capabilities. Firstly, Transformers excel at processing sequence data, a crucial feature considering the temporal nature of user engagement. Their self-attention mechanism allows them to weigh the relevance of each user cue in its temporal context, thereby accurately capturing the evolution of user sentiment over time. Secondly, Transformers can learn complex relationships within the data, a requisite for understanding the intricate connections between diverse user cues and their corresponding sentiments. Lastly, Transformers are highly scalable, capable of handling a vast array of user cues. Although they require considerable computational resources and substantial data for training, their proficiency in capturing meaningful temporal patterns and their capacity to process high-dimensional data make them aptly suitable for this task, providing a robust and nuanced understanding of user sentiment.

Thus, in one embodiment of this invention, we utilize a transformer-based pipeline for sentiment estimation.

To deduce sentiment from user engagement patterns, a sequence of user cues {x1, x2, . . . , xₙ} is first gathered, where n represents the total number of user interactions recorded. These cues are encoded into high-dimensional vectors using an appropriate embedding function E: x→E(x), which transforms each cue into a corresponding vector in the embedding space.

The system can accommodate a wide variety of user interactions, each of which, and each combination of which, can be considered as embodiments. Click patterns, characterized by parameters such as Euclidean coordinates, element, or region ID, and click duration, serve as one such embodiment, transformed into high-dimensional vectors. Similarly, in another embodiment, swipe patterns are encoded based on characteristics including direction, speed, length, and curvature. Conventional engagement metrics, such as view duration, are processed analogously in yet another embodiment.

Facial expressions constitute another embodiment, where an appropriate embedding function translates either facial landmark sequences or raw pixel data into vector representations, utilizing deep learning techniques like CNNs or Autoencoders. Speech, serving as another embodiment, can be transformed into high-dimensional embeddings using deep learning techniques, based on MFCCs or spectrogram data. For textual cues, in another embodiment, embedding functions such as Word2Vec, GloVe, or FastText can be employed.

Neurological data, specifically raw EEG data, in another embodiment, can be mapped to high-dimensional vectors using deep learning or unsupervised techniques like autoencoders. When the system encounters multiple modalities of user cues, in another embodiment, separate embeddings for each modality can be generated and subsequently amalgamated into a singular representation. This synthesis can be accomplished through methods like concatenation, averaging, deep learning, or applying multimodal fusion techniques such as Canonical Correlation Analysis (CCA) or Deep Canonical Correlation Analysis (DCCA).

These embedded vectors are then input to a Transformer model. Inside the Transformer, the self-attention mechanism computes attention scores for all pairs of inputs, capturing the dependencies between different cues and their context within the sequence. Formally, the attention score α_{i,j} between an input pair (xᵢ, xⱼ) is calculated as a SoftMax over the dot product of the input vectors, as follows:

$${α}_{i j} = \frac{exp ( \frac{E ( {x}_{i} ) \cdot E ( {x}_{j} )}{\sqrt{d}} )}{{Σ}_{k = 1}^{n} exp ( \frac{E ( {x}_{i} ) \cdot E ( {x}_{k} )}{\sqrt{d}} )}$$

where d is the dimension of the embedding space, and the dot product represents the similarity between the embedded cues. These attention scores serve as weights to produce a context-sensitive representation of each input cue.

The Transformer outputs a sequence of context-sensitive vectors {y₁, y₂, . . . , yₙ}. Each vector yᵢ represents the i-th user cue in the context of all other cues. This output sequence is then mapped to a lower-dimensional latent space via a learned mapping function M: y→M(y).

The training of the Transformer model using user-independent data entails an optimization procedure that progressively adjusts the parameters of the model to reduce the discrepancy between predicted and actual sentiments. The dataset for training, denoted as D={(x₁, s₁), (x₂, s₂), . . . ,(xₘ,sₘ)}, encompasses sequences of user cues xi and corresponding ground truth sentiments sᵢ, ascertained from fine-grained affective states during an offline analysis.

During each training epoch, the process initiates with forward propagation. Here, each sequence xi is transformed into high-dimensional vectors via the embedding function E: xᵢ→E(xᵢ). These vectors are then fed into the Transformer, generating a sequence of context-aware output vectors: E(xᵢ)→T(E(xᵢ)). These output vectors are subsequently projected onto the latent sentiment space using a learned mapping function M, yielding the predicted sentiment: T(E(xᵢ))→M(T(E(xᵢ))).

The system then computes the loss L, which quantifies the difference between the predicted sentiment M(T(E(xᵢ))) and the true sentiment sᵢ. This loss is typically calculated using a suitable loss function for the task; in the provided embodiment, we use Mean Squared Error: L=Loss(M(T(E(xᵢ))),sᵢ).

Next, the process involves backward propagation to compute the partial derivatives of the loss L with respect to the parameters of the Transformer, the embedding function E, and the mapping function M. The parameter update step uses these gradients to adjust the parameters of the Transformer, E, and M. Specifically, each parameter θ is updated according to the rule θ=θ−η∇θL, where ηis the learning rate and ∇θL is the gradient of the loss with respect to θ. This update is performed using an optimization algorithm which, depending on the embodiment, may be Stochastic Gradient Descent (SGD), Adaptive Moment Estimation (Adam), or others.

Lastly, the model's performance is periodically evaluated on a validation set to monitor overfitting and to gauge the model's ability to generalize to unseen data. The training process is iterated until a stopping criterion is reached, The stopping criterion, depending on the embodiment, is determined by a predefined number of epochs or threshold validation performance. The final product of this procedure is a Transformer model proficiently trained to infer user sentiment from engagement patterns.

Building upon the initial user-independent training, the Transformer model can be further refined using real-time self-supervised learning to tailor its understanding to individual users, thereby transitioning from a user-independent to a user-dependent model.

Self-supervised learning exploits the inherent structure of the data to generate labels, enabling the model to learn from the data itself without requiring explicit annotations. In the context of this system, the model can use user cues as input and predict subsequent cues or patterns as a self-supervision task. For instance, given a sequence of user cues up to time t, the model can predict the cue at time t+1.

Specifically, let's denote a sequence of real-time user cues as {x₁, x₂, . . . , xₜ}. The model predicts the next cue xₜ₊₁ based on the current sequence. Once the actual next cue is observed, the model calculates the discrepancy between the predicted and actual cue as the loss using similar functions as described above. This loss is then backpropagated through the model, and the parameters are updated accordingly based on policies specified by the optimizers specified above, thereby fine-tuning the model to better predict the specific user's behavior.

Mathematically, the predicted cue xₜ₊₁′=M(T(E({x₁, x₂, . . . , xₜ}))), and the loss can be calculated as L=Loss(xₜ₊₁′, xₜ₊₁). The gradients of the loss with respect to the model parameters are ∇θL, and the parameters are updated using the rule θ=θ−η∇θL, where η is the learning rate.

### Media Generation

The invention includes a media generation system, akin to an autoencoder's decoding section, to create media content that aligns with and aims to shift the user's current sentiment. This time-aware generative system uses the user's current sentiment and previously generated media to produce multiple media continuations suited to the desired sentiment, which is considered as context by the models. The quantity of these continuations is adjustable, allowing adaptable media content selection. Designed for versatility, the media generation system accommodates various formats and continuation. Each media format might have a specific generation system design to cater to its unique needs and characteristics.

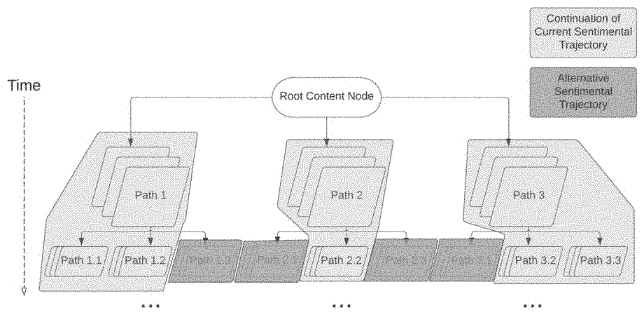

As shown in FIG. 2, the continuations outputted by the media generation system are conceptually analogous to children nodes in a decision tree structure, wherein each node corresponds to a media continuation with a specific intended sentiment. As the tree branches out, additional nodes represent further media continuations, each derived from the data and context belonging to its parent.

Although many methods of media generation can satisfy the requirements of this pipeline, and the chosen method does not restrict the scope of this disclosure, we focus on an embodiment that utilizes text-to-text models which self-prompt text-to-video models. Initially, a text-to-text transformation model is utilized to generate a narrative script. This model is informed by a vector representing the affective difference between a user's current emotional state and the desired emotional state (the differential sentiment space), in conjunction with the contextual information from previously generated media. Subsequently, a text-to-video transformation model is employed to convert the generated narrative script into a video representation, thereby enabling an effective transition of the user's sentiment from its current state to the desired state through the interaction with the generated media content.

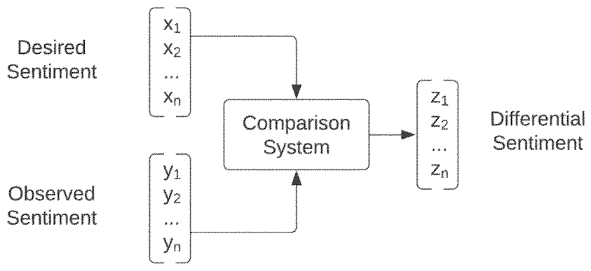

The present pipeline begins by computing textual representations of the differential sentiment space, shown in FIG. 3. This is done using the initial interpretation of the latent sentiment space as distinct fine-grained affect states that the user may experience. A segment of text for each sentiment and its associated valence in the space is deterministically computed.

In this embodiment, the text-to-text query provides additional context from the completed media to ensure continuations maintain consistency, avoiding any contradictory or disregarded elements. These elements, referred to as threads, enhance the media's logical and sentimental coherence, and can be applied to and form of media.

The textual representation of the differential sentiment space and additional context are then incorporated into a textual template. In this embodiment, the template is:
“generate a coherent continuation of media with context [insert context] and addressing the emotional state [insert differential sentiment state] that would be suitable for [insert media format/mode].”

This template is used to prompt a generative text-to-text system, such as GPT-4 or T5, to produce a potential media continuation. These models use deep learning techniques like transformer architectures, which allow them to understand and generate contextually relevant text based on the provided prompts.

To ensure compatibility with the text-to-video models, such as VQGAN+CLIP, and maintain consistency between them, the template may undergo revisions during offline training cycles. These revisions help fine-tune the models, enhancing their ability to understand and generate coherent media continuations. Finally, the output of the text-to-text model is inputted into a generative text-to-video model and the output is recorded.

In a specific embodiment, the output is validated to ensure coherence and sentimental alignment as a continuation of the previously generated media. Moreover, in another embodiment, the text-to-text prompt may utilize a transition between the perceived user's sentiment and the desired sentiment, rather than a differential sentiment estimation, such as the following:
“generate a coherent continuation of media with context [insert context] and to transition between [user's current sentiment] and [desired sentiment] that would be apt for [insert media format/mode]”

In yet another embodiment, the text-to-text prompting is augmented with the vectorized differential sentiment state as context, rather than computing a textual representation.

In the present invention, two systems, a text-to-text generator (Model₁) and a text-to-video generator (Model₂), are trained using Reinforcement Learning (RL) algorithms. These systems are conceptualized as separate agents within a multi-agent reinforcement learning (MARL) framework. This design enables the models to learn both from their own actions and the actions of the other model, encouraging complex and cooperative learning dynamics.

At each training step, Model₁ generates a text sequence from a provided prompt, which can be represented as s₁=f₁(prompt, θ₁). Subsequently, Model₂ generates a video based on the text output from Modell, represented as s₂=f₂(s₁, θ₂). Here, f₁ and f₂ represent functions implemented by Model₁ and Model₂ respectively. The terms s₁ and s₂ are the generated outputs, and θ₁ and θ₂ symbolize the parameters of the two models.

The joint reward function, Rⱼₒᵢₙₜ, can be defined as Rⱼₒᵢₙₜ=R₁(s₁, s_{target})+R₂ (s₂, v_{target}) where R₁ and R₂ are the respective reward functions for Model₁ and Model₂, s_{target} represents the target sentiment for the text, and v_{target} symbolizes the target sentiment for the video. This reward structure is designed to give a higher reward when the generated text or video aligns more closely with the target sentiment.

The RL algorithm employs policy gradient methods to update the parameters of both models based on the joint reward. The update rules for Model₁ and Model₂ can be expressed as:

∇_{θ}_{₁}J(θ₁)=E_{π}_{₁}[γ^{t}∇_{θ}_{₁}log π₁(a₁|s₁, θ₁)Rⱼₒᵢₙₜ] and

∇_{θ}_{₂}J(θ₂)=E_{π}_{₂}[γ^{t}∇_{θ}_{₂}log π₂(a₂|s₂, θ₂)Rⱼₒᵢₙₜ],

where γ is the discount factor, which prioritizes immediate rewards over future ones. The models' parameters are updated iteratively in this way, with both models learning from the joint reward and each other's output.

In MARL, the agents' policies π₁ and π₂ not only depend on their own states s₁ and s₂, but also on the states and actions of the other agent. The joint reward function and policy update rules are modified to account for these inter-agent dependencies. For instance, the policy update rules include terms reflecting the influence of the other agent's actions:

Rⱼₒᵢₙₜ=R₁(s₁, a₁, s₂, a₁)+R₂(s₂, a2, s₁, a₁),

∇_{θ}_{₁}J(θ₁)=E_{π}_{₁}[γ^{t}∇_{θ}_{₁} log π₁(a₁|s₁, a₂, θ₁)Rⱼₒᵢₙₜ],

∇_{θ}_{₂}J(θ₂)=E_{π}_{₂}[γ^{t}∇_{θ}_{₂} log π₂(a₂|s₂, a₁, θ₂)Rⱼₒᵢₙₜ],

a₁a₂ϵϵ1—ϵ where and denote the actions taken by Model₁ and Model₂, respectively. a₁a₂ϵϵ1—ϵ To manage the exploration-exploitation trade-off, an -greedy policy is used. With a probability, an action is randomly selected, fostering exploration. Conversely, with a probability, the action believed to yield the highest reward (based on current knowledge) is selected, promoting exploitation. By striking this balance, the models are encouraged to explore various strategies while still making progress towards the overall goal.

Several reinforcement learning algorithms could be employed in this context, including Q-Learning, SARSA (State-Action-Reward-State-Action), and Proximal Policy Optimization (PPO), and thus reach represent different embodiments of the present invention. These algorithms differ in how they balance exploration and exploitation, and how they update their estimates of the value function or policy.

Q-Learning is a value-based method that iteratively updates the action-value function Q(s, a), which represents the expected return for taking action a in state s. The update rule for Q-learning is given by:

Q(s, a)←Q(s, a)+α[r+γ maxₐ′Q(s′, a′)−Q(s, a)],

where α is the learning rate, γ is the discount factor, r is the reward, s′ is the next state, and a′ is the action taken in state s′.

SARSA is another value-based method, but unlike Q-Learning, it's an on-policy method, meaning it updates its action-value estimates based on the policy it's currently following. The update rule for SARSA is:

Q(s, a)←Q(s, a)+α[r+γQ(s′, a′)−Q(s, a)],

where s′, a′ are the next state and action following the current policy.

Proximal Policy Optimization (PPO) is a policy-based method that directly optimizes the policy function π(a|s, θ) parameterized by θ. PPO aims to take a step in the direction that improves the policy, but not too large a step that it deviates significantly from the current policy. The objective function for PPO is:

L(θ)=Eₜ[min(pₜ(θ)Aₜ, clip (pₜ(θ),1−ϵ, 1+ϵ)Aₜ)],

where pₜ(θ)=π(aₜ|sₜ, θ)/π(aₜ|sₜ, θ_{old}) is the probability ratio, Aₜ is the advantage function at time t, and ϵ is a hyperparameter that limits the step size.

Through this process, the models learn to generate media continuations that are not only coherent and contextually appropriate, but also effective in shifting the user's sentiment as intended. The use of reinforcement learning, particularly within a multi-agent framework, allows the system to continuously adapt and optimize its performance over time, enhancing the user's experience with the generated media content.

### Real-Time Pipeline

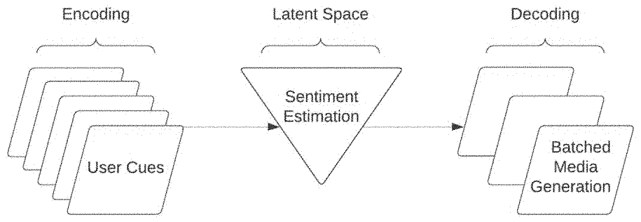

As previously described and shown in FIG. 4, the autoencoding structure of the invention is comprised generally of a decoding portion where the user cues are gathered, and sentiment estimated as a latent space. Subsequently, the estimated sentiment is decoded through the media generation system, which outputs possible continuations and associated intended sentiments.

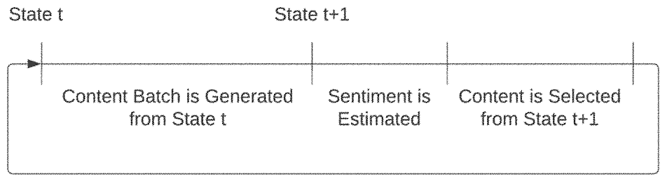

To enable real-time efficacy, we must optimize the timeline of the pipeline cycle to accommodate potential computational limitations. To allow for sufficient generation time, we utilize a delayed user cue observation period which enhances sentiment fidelity. The adaptive cycle proceeds from the initial observation of user cues and begins content generation, at the completion of which user cues are observed again and used to decide which generated continuation to present to the user. This cycle ensures that the media displayed to the user is never disrupted as its display period happens simultaneously with the generation of the next continuation of the media. In one embodiment, the media generation system is retrained using a parallelized system. In another embodiment, the media generation system is retrained in sequence with the other steps discussed. This timeline is illustrated in FIG. 5.

The initial media selection in this invention, akin to the decision tree's root node, is based on an estimation of the user's desired sentiment using both prior user data and population-level data, since session-level user data is not yet available. The desired sentiment, which can be conveyed by the user through genre selection or recent engagement preferences, is heavily dependent on the mode, and certainly not confined to these expressions. Despite its randomness, this stage is unaffected by session-specific optimizations. Upon presentation, the real-time feedback loop commences.

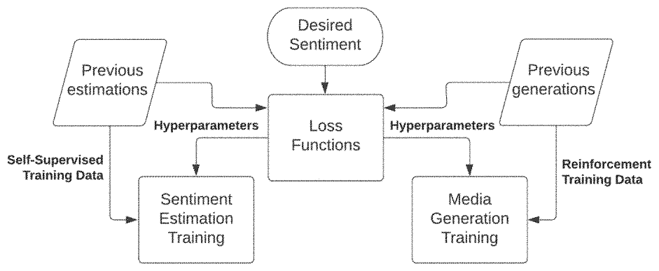

The real-time pipeline continuously refines both sentiment estimation and media generation processes. As shown in FIG. 6, it continuously supplies data for self-supervised training to enhance sentiment estimation, and for the reinforcement model's training loop to improve media generation, as well as its sentiment precision and fidelity. Both pipelines can undergo either batch-wise or continuous training. Furthermore, in a specific embodiment, the hyperparameters affecting the respective training optimizers can be modified throughout the course of a user's session, enabling a dynamic rate of sentiment and media generation alterations.

The present invention employs a comparison mechanism to ascertain the optimal vector direction necessary for influencing user sentiment. This method entails contrasting the user's existing sentiment vector with a desired sentiment vector, as shown in FIG. 3. The relationship between these vectors signifies the necessary modification in sentiment. In one embodiment, the system calculates the Euclidean distance between these vectors, an approach particularly effective in instances where the sentiment space exhibits a linear and symmetrical structure. Alternatively, more intricate deep learning methodologies, such as neural networks, can be harnessed to discern the vector discrepancy. These embodiments may or may not be constant between user-dependent systems, as individuals' sentiment may behave differently. This approach proves beneficial when the sentiment space exhibits complex, nonlinear interrelationships that defy simpler geometric methods.

The media selection subsystem enhances the sentiment fidelity of the real-time pipeline by reconciling the variance between the user's sentiment and the system's interpretation of it. This is accomplished by dynamically adjusting the exploitation/exploration ratio of the implemented optimization process that selects media corresponding to its anticipated sentiment labels. If the system effectively mirrors the user's desired sentiment, it persists in selecting media with congruent sentiment labels. Conversely, if there's a misalignment, it deliberately opts for media with divergent sentiment labels. This strategy facilitates the discovery of latent user-specific preferences and expands the diversity of the training data, thus augmenting the granularity of its user-specific model through its training cycles. The array of optimization algorithms employed may encompass, but is not limited to, Adaptive Moment Estimation (Adam), Stochastic Gradient Descent (SGD), Simulated Annealing, Genetic Algorithms, Bayesian Optimization, Q-Learning, and Bandit Algorithms.

Finally, the generated and selected media is concatenated to the running media buffer which is continually displayed to the user in real-time. This buffer allows for there to be slight discrepancies in media generation durations that would otherwise cause users to experience streaming interruptions. The length of this buffer may be variable or constant.

1. A system for the real-time artificial generation of media content, designed specifically to influence the current sentimental state of a user towards another state, facilitated by a sentiment encoding and media decoding pipeline and continually refined through a sentiment prediction feedback loop.

2. A system which encodes user sentiment estimations in real-time into a latent space, with constituent dimensions representing pre-determined fine-grained affective states, which is then subsequently decoded into artificially constructed media optimized to influence the user towards a specific sentimental state, using the resulting sentimental reactions to continually refine the pipeline's behavior.

3. A system utilizing a pipeline of large language model prompting and text-to-video generative systems in real-time to produce contextually coherent branches of media based on user sentimental state, desired sentimental state, and past media, which is informed using a sentiment feedback loop attending to user cues and refined using multi-agent reinforcement learning.

4. The system of claim 3, wherein the system continuously monitors and analyzes reactions from the user and computationally adjusts the media content accordingly.

5. The system of claim 2, wherein the sentiment estimation models aim to establish an understanding of the cause-and-effect relationship between artificially generated media content and user sentiment using reinforcement techniques, taking as context both the predicted sentiment state associated with the media and the multimodal cues exhibited by the user.

6. The system of claim 1, wherein the system adapts the presentation of information according to an estimation of users' comprehension and cognitive preferences.

7. The system of claim 1, wherein each instance of user interaction or batched events triggers the generation of new content.

8. The system of claim 2, wherein the system generates multiple media continuations in accordance with the user's current sentiment state and uses their evolving state to subsequently inform a singular selection.

9. The system of claim 8, wherein the user's reaction and/or response to the presented media during generation partially or fully informs the selection of media continuation from the generated set.

10. The system of claim 3, wherein the generation of media is partially informed by the estimated differential sentiment state.

11. The system of claim 2, wherein the generation of media utilizes a pipeline consisting of any combination of text-to-text, text-to-video, text-to-image, text, and text-to-sound system prompting.

12. The system of claim 1, wherein media coherence is largely dictated by method of prompting large language models.

13. The system of claim 2, wherein the training and/or fine-tuning methodologies of the text-to-media pipeline utilize multi-agent learning approaches.

14. The system of claim 1, wherein the sentiment estimation step is designed using a transformer architecture, taking as context past sentimental states.

15. The system of claim 1, wherein the sentiment estimation step is designed using temporal convolutional neural architecture, taking as context past sentimental states.

16. The system of claim 2, wherein the behavior of the sentiment estimation and media generation pipeline acts in accordance with exploration-exploitation optimization schemes to map the user's affective space.

17. The system of claim 1, wherein the adaptive pipeline is initialized for a given user with user-independent sentiment estimation and media generation models and is subsequently fine-tuned to become user-dependent.
